(19) United States
(12) Patent Application Publication
(10) Pub. No.: US 2024/0039011 A1
(43) Pub. Date: Feb. 1, 2024

(54) HYBRID FABRICATION METHOD FOR FUEL CELL FLOW FIELDS

(71) Applicant: FuelCell Energy, Inc., Danbury, CT (US)

(72) Inventors: Thomas M. LUCAS, Pleasant Valley, CT (US); Ramakrishnan VENKATARAMAN, Danbury, CT (US); Abdelkader HILMI, Bethel, CT (US); Chao-Yi YUH, New Milford, CT (US)

(21) Appl. No.: 18/227,137

(22) Filed: Jul. 27, 2023

Related U.S. Application Data
(60) Provisional application No. 63/392,999, filed on Jul. 28, 2022.

(51) Int. Cl. H01M 8/0254; H01M 8/0206

(52) U.S. Cl. CPC H01M 8/0254; H01M 8/0206

(57) ABSTRACT

A method of manufacturing a current collector for an electrochemical cell assembly includes providing a base plate including a surface, bend-forming the base plate to create a plurality of open corrugations protruding from the surface, each open corrugation including a first flange and a second flange, and forming a foot between the first flange and the second flange of each open corrugation to close each open corrugation and form a corrugation.

### CROSS-REFERENCE TO RELATED APPLICATIONS

The present application claims the benefit of and priority to U.S. Provisional Patent App. No. 63/392,999, filed Jul. 28, 2022, the entire disclosure of which is incorporated by reference herein.

### BACKGROUND

The present invention relates generally to the field of fuel cells and, in particular, to the manufacture of current collectors (e.g., gas flow fields, corrugated flow fields, etc.) for use in fuel cells that are for use in fuel cell stacks and systems.

A fuel cell is a device that directly converts chemical energy stored in hydrocarbon fuel into electrical energy by means of an electrochemical reaction. Generally, a fuel cell comprises an anode and a cathode separated by an electrolyte, which serves to conduct electrically charged ions.

### SUMMARY

According to an aspect of the present disclosure, a method of manufacturing a current collector for an electrochemical cell assembly is provided. The method includes providing a base plate including a surface, bend-forming the base plate to create a plurality of open corrugations protruding from the surface, each open corrugation including a first flange and a second flange, and forming a foot between the first flange and the second flange of each open corrugation to close each open corrugation and form a corrugation.

In some embodiments, the feet are formed using selective laser sintering, selective laser melting, laser metal deposition, or other additive manufacturing methods.

In some embodiments, the feet are made from a different material than the base plate.

In some embodiments, the feet are made from nickel or a nickel alloy.

In some embodiments, the current collector is a cathode current collector and the feet are made from aluminum or an aluminum alloy.

In some embodiments, one or more of the feet fill all or substantially all of the corresponding open corrugation to form a sealed corrugation such that gas flow is substantially blocked between the one or more of the feet and the surface of the base plate. In some embodiments, a pattern of sealed or restricted-opening corrugations is configured to control a gas flow path through the current collector.

In some embodiments, the method further includes cutting a pre-bend corrugation pattern into the base plate. In some embodiments, the pre-bend corrugation pattern is cut by a die.

In some embodiments, the method further includes applying a surface treatment to a surface of each first flange and a surface of each second flange to improve bonds between the foot and the flanges.

In another aspect of the present disclosure, a current collector for an electrochemical cell assembly is provided. The current collector includes a base plate made from a first material and a plurality of corrugations. Each corrugation includes a first flange, a second flange, and a foot formed between the first flange and the second flange, and one or more of the feet are made from a second material.

In some embodiments, the feet are metallically joined to the flanges.

In some embodiments, the first material is stainless steel and the second material is nickel or a nickel alloy.

In some embodiments, the first material is stainless steel and the second material is aluminum or an aluminum alloy.

In some embodiments, one or more of the feet substantially fill a space between the first flange and the second flange of a corresponding corrugation such that gas flow between the one or more of the feet and a surface of the base plate is substantially blocked. In some embodiments, a pattern of sealed open corrugations is configured to control a gas flow path through the current collector.

In some embodiments, the first flange and the second flange of each corrugation is formed from a bent portion of the base plate.

In another aspect of the present disclosure, an electrochemical cell stack is provided. The electrochemical cell stack includes a fuel cell including an anode and a cathode, a bipolar plate, and a current collector disposed between the bipolar plate and the fuel cell. The current collector includes a first surface in contact with the bipolar plate and plurality of corrugations each including two flanges and a foot extending between the two flanges. The foot of at least one of the plurality of corrugations is made from a material that is different than a material of the corresponding flanges.

In some embodiments, the first material is nickel or a nickel alloy and the feet are in contact with the anode or the cathode.

In some embodiments, the first material is aluminum or an aluminum alloy and the feet are in contact with the cathode.

### BRIEF DESCRIPTION OF THE DRAWINGS

FIG. 1 is a side schematic view of a portion of a prior art fuel cell.

FIG. 2 is an perspective view of a portion of a prior art current collector for a fuel cell.

FIGS. 3A-3D are schematic illustrations of a sequence for forming corrugations on a current collector, according to an exemplary embodiment.

FIG. 4 is an illustration of a foot being formed on flanges of a corrugation using selective laser sintering, according to an exemplary embodiment.

FIG. 5 is an illustration of a foot being formed on flanges of a corrugation using laser metal deposition, according to an exemplary embodiment.

FIG. 6 is an illustration of a portion of a current collector, according to an exemplary embodiment.

FIG. 7 is an illustration of a foot being formed on flanges of a corrugation using selective laser sintering, according to an exemplary embodiment.

FIG. 8 is an illustration of the completed corrugation shown in FIG. 7.

FIG. 9 is an illustration of wave-shaped corrugations with feet of varying size, according to exemplary embodiments.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

In order to produce a useful power level, a number of individual fuel cells may be arranged in a stack with an electrically conductive separator assembly between each cell. The separator assembly may include a bipolar plate for isolating fuel from the oxidant stream of the neighboring fuel cell, an anode current collector (often provided as a corrugated plate) for conducting electric current from the anode electrode, and a cathode current collector (often provided as a corrugated plate) for conducting electric current from the cathode electrode. The anode current collector may be in contact with the anode electrode and may define flow channels for the fuel gas. The cathode current collector may be in contact with the cathode electrode and may define flow channels for the oxidant gas.

The corrugations in the current collectors may be formed using a draw forming process in which a pattern is stamped into a flat plate. The draw forming process may result in thinning of the plate material in certain locations where the material is stretched to form the corrugations, which may contribute to a reduced lifespan for the current collector. Additionally, draw forming can impart stresses into the formed and surrounding material and may reduce the flatness of the corrugations and the flow field as a whole, which in turn may cause non-uniformity in contact pressure between cell components and reduce electrical conductivity. Accordingly, it would be beneficial to develop a manufacturing method for corrugated current collectors that improves the flatness of the corrugations and reduces thinning of the material.

Additive manufacturing is a manufacturing method in which material is deposited and formed into a desired shape. Examples of additive manufacturing processes include selective laser sintering (in which layers of powder are selectively heated by a precision laser and fused together to form a three-dimensional component), selective laser melting (in which a high power-density laser is used to melt and fuse metallic powders), and laser metal deposition, in which a stream of metal powder is deposited and immediately melted by a laser to form a three dimensional component. According to some embodiments, corrugations in a current collector can be formed by bend forming a flat plate to form open corrugations, each comprising two flanges, and then using an additive manufacturing process to form a foot between the flanges. This can reduce thinning caused by draw forming the entire corrugation, can result in flatter feet and flatter corrugated flow fields as a whole for better electrical conductivity and contact pressure uniformity, and can allow the feet to be made from a different material from the rest of the current collector.

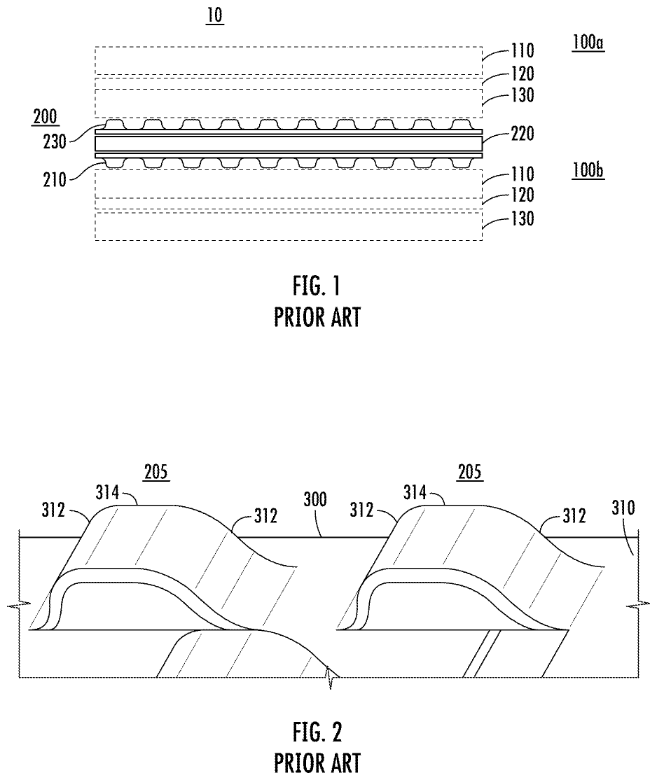

Referring to FIG. 1, a portion of a typical fuel cell stack 10 is shown. A first fuel cell 100a and a second fuel cell 100b are shown, each with an electrolyte 120 sandwiched between two electrodes, a cathode 110 and an anode 130. Between the two fuel cells may be a separator assembly 200, which includes a bipolar plate 220 between a cathode current collector 210 and an anode current collector 230. Current collectors may also be referred to as flow fields or flow field plates. The current collectors may serve to distribute fuel and oxidant gases to the electrodes as well as to provide electrical connections between the fuel cells. The anode current collector 230 may include a number of corrugations 205 that control the flow pattern of the fuel over the anode 130 of the first fuel cell 100a. Similarly, the cathode current collector 210 may include a number of corrugations 205 that control the flow pattern of the oxidant over the cathode 110 of the second fuel cell 100b. The bipolar plate 220 may fluidly isolate the fuel flowing over the anode 130 of the first fuel cell 100a from the oxidant flowing over the cathode 110 of the second fuel cell 100b. Corrugated current collectors may be most often employed in molten carbonate fuel cell (MCFC) stacks but may also be used in other types of fuel cell stacks, such as solid oxide fuel cell (SOFC) stacks. A typical fuel cell stack may have several fuel cells with a separator assembly 200 between each. Electrolysis (e.g., electrolyzer) cell stacks, such as solid oxide electrolysis cell (SOEC) stacks and molten carbonate electrolysis cell stacks (MCEC) stacks, may also include corrugated flow fields. In SOECs, steam may be supplied to and distributed by the cathode current collector, and an electrical current may be supplied to the cell to split water molecules into hydrogen gas, which remains on the cathode side, and oxygen gas, which crosses over to the anode side. In MCECs, steam and carbon dioxide are supplied to and distributed by the cathode current collector, and an electrical current may be supplied to the cell. Hydrogen gas may remain on the cathode side, while oxygen and carbon dioxide cross over to the anode side.

FIG. 2 shows a detailed view of a section of a typical current collector 300, which may be an anode current collector 230 or a cathode current collector 210, showing the corrugations 205. Note that a current collector 300 may have thousands of corrugations 205. The corrugations 205 may be roughly wave-shaped when viewed from the side, with a substantially flat top portion. The sides of the “wave” are referred to herein as “flanges” 312. The top part of the “wave” may be referred to as a “foot” 314, or collectively “feet” 314. In some cases, the flanges 312 may be substantially perpendicular to the feet 314, such that the corrugations 205 appear roughly as square waves when viewed from the side. During operation, gas may flow through the corrugations 205, between the feet 314 and a surface (e.g., the upper surface) of the current collector 300.

Current collectors 300 may typically be manufactured by draw forming a flat plate of metal, typically stainless steel. The flat plate may be placed into one or more patterned dies, and the corrugations 205 are stamped in with mechanical pressure. While this manufacturing method is fast, it may be difficult to control the flatness of the feet 314 and the flatness of the entire corrugated flow field 210, 230. Flat feet 314 and flat corrugated flow fields 210, 230 can be desirable because they allow for more contact area between the current collectors 300 and the electrodes of the fuel cells, as well as more contact area between the corrugated flow fields 210, 230 and the bipolar plate 220, which improves conductance and energy capture. Furthermore, a lack of flatness of the overall current collector 300 can impart mechanical stresses into the electrodes in the stack and could cause damage, particularly to the ceramic cathode of a molten carbonate fuel cell.

To form each of the flanges 312 and feet 314, a portion of the flat plate may be stretched into the shape of the corrugation 205. The length of corrugation 205 (e.g., the length of material tracing the profile of the corrugation 205) is longer than the length of the corresponding area of flat plate material before it is stamped into the corrugation shape. When the material is stretched to a greater length, the thickness of the stretched portion necessarily decreases, and the stretching imparts stress into the material. The thinning of the material limits the maximum height of the corrugations 205. Furthermore, due to the corrosive environment in the fuel cell stack during operation, the reduced thickness can cause the current collector 300 to break down more quickly. Also, the imparted stresses in the material may cause the corrugations to be irregularly shaped and not flat.

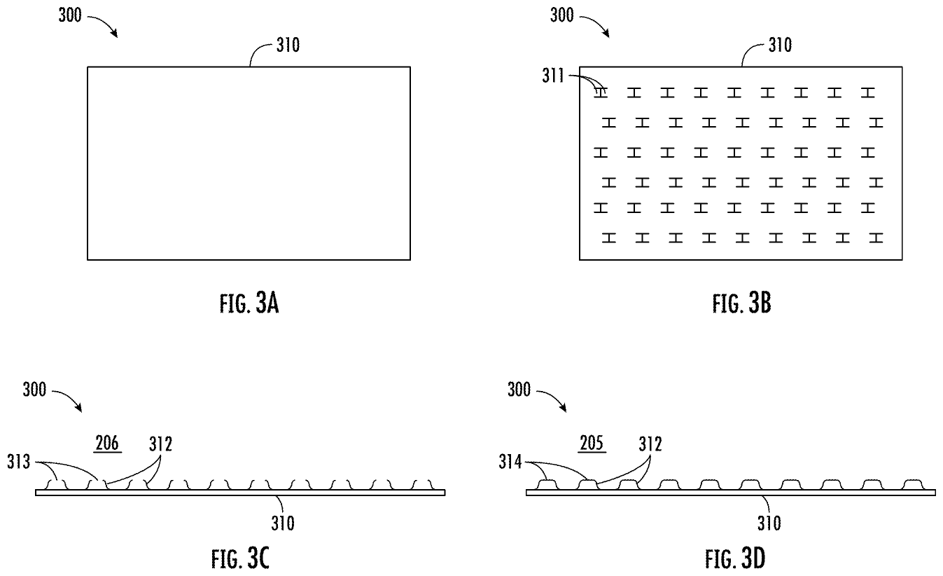

To avoid the issues associated with the formation of corrugations as described with respect to FIGS. 1-2, an improved method of forming corrugations has been developed that will now be discussed in detail. Referring to FIGS. 3A-3D, a current collector 300 in accordance with the present disclosure is shown in various stages of manufacture, according to an exemplary embodiment. In FIG. 3A, a top view of a base plate 310 is shown which will form the base of the current collector 300. The base plate 310 may be made of stainless steel according to an exemplary embodiment. According to other exemplary embodiments, any suitable material with sufficient ductility and conductivity may be used. The base plate 310 may be placed into a die which cuts a pre-bend corrugation pattern into the base plate 310, as shown from the top in FIG. 3B. These cuts may be made by other manufacturing methods as well, such as laser cutting. Each corrugation pre-cut may generally be in the shape of a capital “H,” creating two flaps 311 that will become the two flanges 312 of the corrugation. Next, the plate may be placed into another die, which bends the flaps 311 into the flange shape, as shown as a section cut from the side in FIG. 3C. Because the flaps 311 are bent, rather than stretched via draw forming, there is much less thinning of the material and fewer imparted stresses, but there is a gap 313 between each pair of flanges 312. A pair of flanges 312 without a corresponding foot 314 is referred to herein as an “open corrugation” 206. Next, an additive manufacturing process may be used to deposit material on the ends of the flanges 312 to connect the flanges 312 and form the feet 314 to form a completed corrugation 205, as shown as a section cut in from the side FIG. 3D, metallically joining the feet 314 to the flanges 312. The additive manufacturing process may be, but is not limited to, selective laser melting, selective laser sintering, laser metal deposition, sputtering, or other types of 3D printing now known or hereafter developed. In some embodiments, the feet 314 may be welded to the flanges 312. In some embodiments, a surface of each flange 312 (e.g., the ends of the flanges) may undergo a surface treatment such as mechanical abrasion, sandblasting, sanding, or cleaning with a chemical solvent, to improve the bond between the flanges 312 and the foot 314. The surface treatment may be helpful in improving the bond strength between dissimilar materials, for example, between aluminum or aluminum alloys and stainless steel. Current collectors 300 as discussed herein may be used in SOFC stacks, MCFC stacks, SOEC stacks, MCEC stacks, and other types of fuel cell stacks and electrolysis cell stacks (e.g., electrochemical cell stacks). In an electrochemical cell stack, a first surface of each current collectors 300 (e.g., the lower surface of the base plate 310) may be in contact with a bipolar plate (e.g., the bipolar plate 220), and the feet 314 may be in contact with an electrode (e.g., an anode, a cathode) of an adjacent electrochemical cell. At least one electrochemical cell and at least one current collector may form an electrochemical cell assembly.

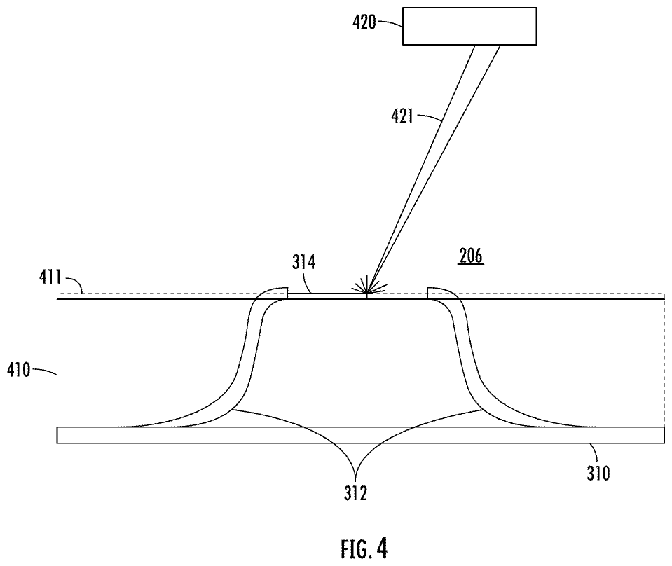

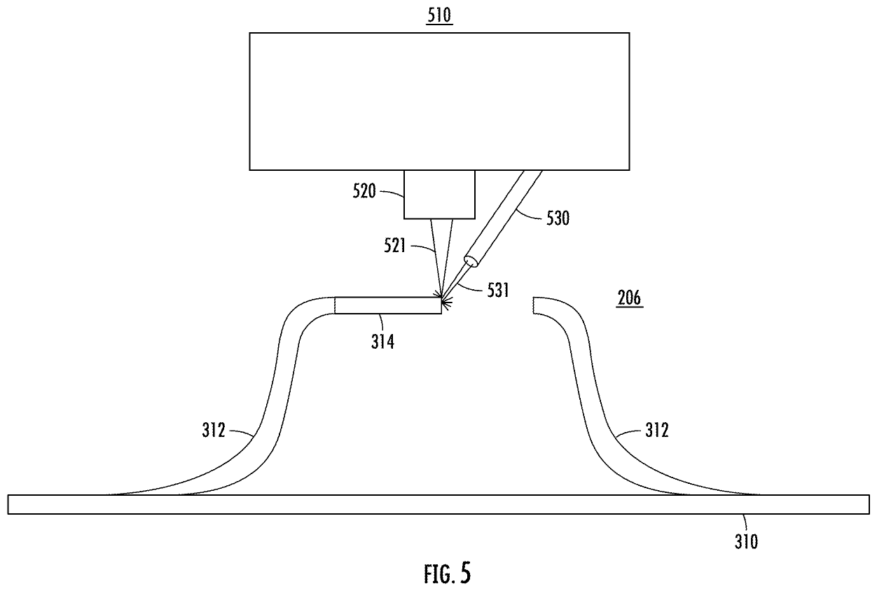

FIG. 4 illustrates how selective laser sintering may be used to form the feet 314 on the flanges 312 of the open corrugations 206, according to an exemplary embodiment. After the initial bend forming process (e.g., forming the open corrugations 206 as shown in FIG. 3C), a bed of metal powder 410 may be built up to the lower edges of the ends of the flanges 312. Next, another layer of metal powder 411 may be deposited over the current collector 300. A laser 420 can expose the spaces between the flanges 312 to a powerful laser beam 421 that briefly heats the top layer of powder. The sections of powder 411 exposed to the laser beam 421 may fuse together and solidify into a thin, solid layer of metal that will become the lowest portion of the foot 314. Another layer of metal powder 411 may then be deposited over the current collector 300, and the area between the flanges 312 may again be exposed to the laser to form another layer of solid metal that will become part of the foot 314. This process may be repeated again several times until the desired thickness of the foot 314 is achieved. The excess powder that is not solidified by the laser beam 421 can then be removed, leaving a completed corrugation 205 in which the foot 314 connects the two flanges 312. A similar process may be used to form feet 314 using selective laser melting. In the selective laser melting process, the laser beam 421 may heat the powder to above its melting point, such that the powder fully melts and solidifies into a layer of metal.

FIG. 5 illustrates how laser metal deposition may be used to form the feet 314 on the flanges 312 of the open corrugations 206, according to an exemplary embodiment. After the initial bend forming process, a laser metal deposition device 510 may deposit metal directly onto the ends of the flanges 312. The laser metal deposition device 510 may include a laser 520 and a metal powder injection nozzle 530. The metal powder injection nozzle 530 outputs a stream of metal powder 531 that may immediately be melted by a laser beam 521 emitted by the laser 520. The melted metal powder 531 may be deposited and quickly solidify on the ends of the flanges 312. Melted metal powder 531 may continue to be deposited on the flanges until the flanges are coupled together by the melted metal powder 531, thus forming a foot 314.

It should be understood by those reviewing the present disclosure that other additive manufacturing techniques, such as 3D printing techniques (whether now known or developed hereafter) may also be used to form the feet according to other exemplary embodiments.

Using these additive manufacturing processes may provide several advantages over the traditional draw forming process. First, because the flanges 312 may be bent instead of stretched, there may be little thinning of the material. This allows the flanges 312 to be roughly the thickness of the base material of the base plate 310. The added thickness may increase the lifespan of the current collector 300 by increasing durability and reducing corrosion sensitivity. Second, this process may allow for improved flatness of the feet 314 and the current collector 300 overall. Because the feet 314 are added after flanges 312 are formed, they may not be subject to the imprecision of the draw forming process. Improved flatness may reduce the stress on the electrodes and increases electrical conductivity and therefore fuel cell stack performance. Third, this process may allow for the materials of the feet 314 to be different than the material of the rest of the current collector 300. One-piece current collectors may typically be made of stainless steel. Better performance can be achieved by using different materials for the feet 314. For example, stainless steel may be used for the base plate 310 and to form the flanges 312, and nickel or a nickel-based alloy (e.g., a nickel-based super alloy such as Inconel®) can be used for the feet 314 in an anode current collector or a cathode current collector to improve electrical conductivity, reducing electrical resistance and heat generation in the fuel cell stack and improving overall performance. In other embodiments, a first alloy of stainless steel may be used for the base plate 310 and flanges 312 and a second alloy of stainless steel may be used for the feet 314. Alternatively, aluminum or an aluminum alloy can be used for the feet 314 in a current collector to improve corrosion resistance. For example, aluminum can be used for the feet 314 in a cathode current collector of a low temperature fuel cell, such as a polymer electrolyte membrane (PEM) fuel cell. Aluminum alloys may be used in high-temperature fuel cells, such as MCFCs and SOFCs. Aluminum alloys may be selected to avoid high contact resistance. In some embodiments, the aluminum alloy may contain about 3 percent aluminum to about 5 percent aluminum, or about 2 percent aluminum to about 6 percent aluminum. In some embodiments, the aluminum or aluminum alloy may be a thin layer deposited on a base material (e.g., a base metal), such as stainless steel. For example, the layer of aluminum may be between about 1 to about 3 microns thick. In some embodiments, the thin layer of aluminum may diffuse into the base material. The composition of a foot 314 may be varied throughout the foot 314 by, for example, changing the composition of the powder layers that are laser sintered. In some embodiments, a percentage of nickel at the point of contact of the foot to the electrode may be higher than at the percentage of nickel in the rest of the foot, which may improve electrical conductivity. For example, the point of contact may be about 10 percent nickel or higher, or between about 8 percent nickel and about 12 percent nickel.

Previously, different materials could only be added to corrugations 205 via cladding operations after the forming of the current collector 300. Cladding only certain areas of the current collector 300 can require accurate masking of the areas not to be clad. Using additive manufacturing processes may allow for the material of each foot 314 to be independently selected without the need for masking. Further, using additive manufacturing allows for different corrugation 205 shapes and thicker feet 314 that may not be possible or practical with draw forming and cladding.

A fourth advantage of using additive manufacturing processes may be that a foot 314 can fill all or substantially all of the corrugation 205, forming a sealed corrugation to block gas flow, allowing for customizable flow patterns. When gases flow over the electrodes of a fuel cell, the reactants may be used up during the chemical reactions that take place in the cell. Due to the nature of the gas flow, the amount of reaction taking place in a cell may be higher in some areas than others, and some of the reactants may pass through the cell without reacting. Further, because the reactions are exothermic, unevenly distributed reactions can cause temperature variations in the electrodes that reduce performance. By controlling flow of the gases over the electrodes, the total utilization of the reactant gases can be maximized, and the temperature can be normalized. Corrugations can be selectively blocked to force the gas to go around the blockage, enhancing mixing of gas streams in different channels. Gas mixing allows better mass transfer of reactants from reactant-rich areas to reactant-lean areas with the cell. In some embodiments, gas flow can be diverted within the cell to change the direction of flow, for example, from perpendicular to parallel within the cell plane. This may allow the fuel and oxidant flow paths to change between a cross-flow alignment and a co-flow or counter flow alignment without needing complex cell designs. In some embodiments, the feet 314 may extend vertically from the flanges 312 before extending across the gap to the opposite flange 312. This may allow for taller corrugations 205, allowing more gas to flow therethrough, without additional thinning of the flanges 312.

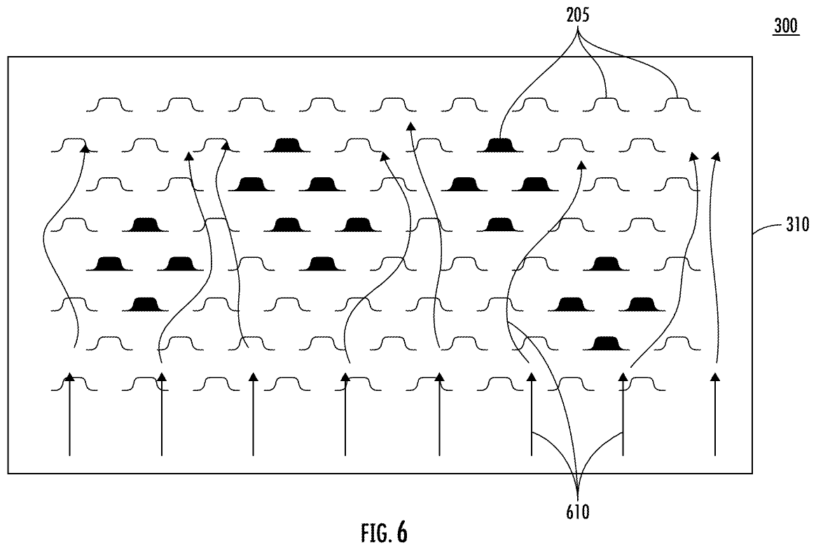

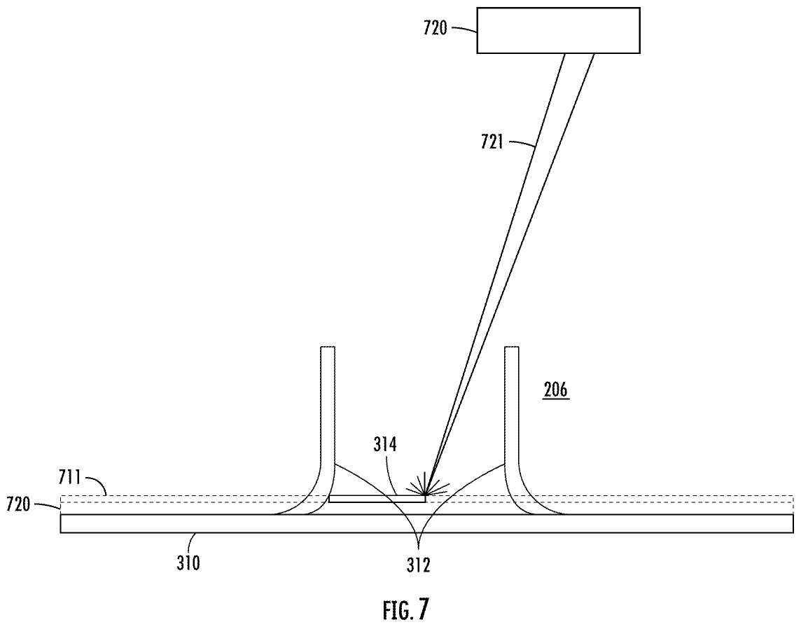

Referring now to FIG. 6, a portion of a current collector 300 according to an exemplary embodiment is shown in which several of the feet 314 fill substantially their entire respective corrugations 205. The arrows indicate the gas flow path 610 of the fuel in the case of an anode current collector, or of the oxidant in the case of a cathode current collector. Gas may be unable to flow through the corrugations 205 that are completely blocked, and the flow through corrugations 205 that are substantially blocked may be substantially reduced. By selectively blocking certain corrugations 205, pattern of sealed corrugations allows the flow path 610 of the reactant gases to be controlled and optimized to improve gas distribution and encourage intra-cell mixing of gas, improving utilization of reactants and efficiency of the fuel cell stack.

FIG. 7 illustrates how selective laser sintering can be used, according to an exemplary embodiment, to form a foot 314 that fills substantially all of an open corrugation 206 with alternatively shaped flanges 312. In some embodiments, the flanges 312 may be bent such that they are substantially perpendicular to the base plate 310. A bed of metal powder 710 may be built up to an area of the flanges 312 that can be reached by a laser beam 721 from a laser 720 without being blocked by the geometry of the flanges 312. Next, another layer of metal powder 711 may be deposited over the current collector 300. The laser 720 may expose the spaces between the flanges 312 to the laser beam 721 that may briefly melt the top layer of powder 711. The sections of powder 711 exposed to the laser beam 721 may solidify into a thin, solid layer of metal that may become the lowest portion of the foot 314. Another layer of metal powder 711 may then be deposited over the current collector 300 and the area between the flanges 312 may again be exposed to the laser beam 721 to form another layer of solid metal that will be part of the foot 314. This process may be repeated again several times until the desired thickness of the foot 314 is achieved. The excess powder 711 that is not solidified by the laser beam 721 is then removed, leaving a completed corrugation in which the foot 314 connects the two flanges 312.

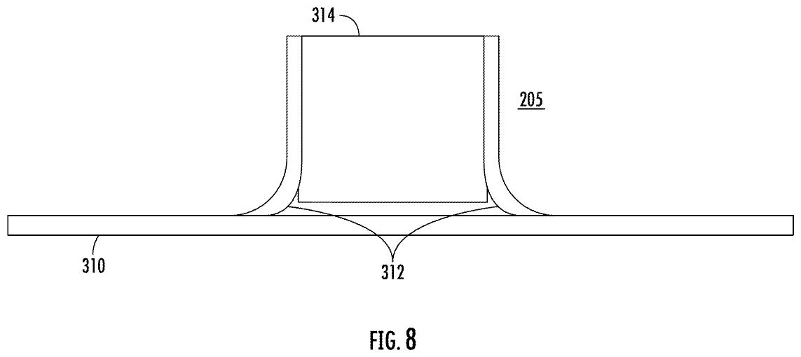

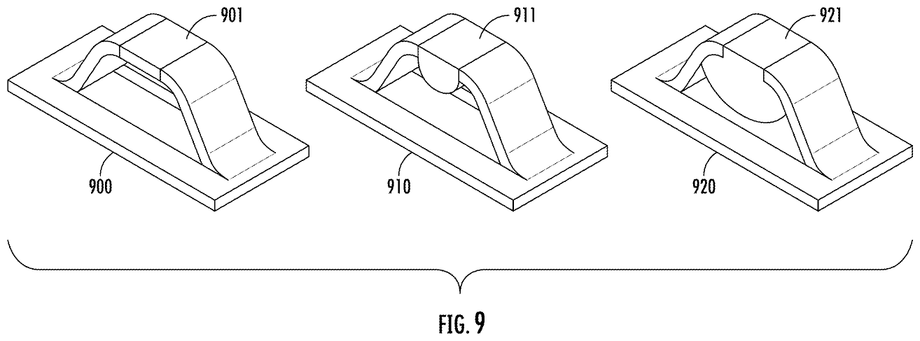

FIG. 8 illustrates a completed corrugation 205 made according to the embodiment shown in FIG. 7. The foot 314 may fill all or substantially all of the corrugation 205 and will block substantially all of fuel or oxidant from flowing through the corrugation 205. While alternatively shaped flanges 312 are shown here, it should be appreciated that a foot 314 may completely or substantially fill a corrugation 205 with various shapes of flanges 312 depending on the specific geometry of the flanges 312 and the angle at which the laser beam 721 can be emitted from the laser 720. For example, FIG. 9 illustrates wave-shaped corrugations 900, 910, 920 with feet 901, 911, 921 of varying size, according to exemplary embodiments. Corrugation 900 has a minimally sized foot 901 that does not fill the corrugation 900 at all. Gas may flow freely through corrugation 900. Corrugation 910 has a foot 911 that partially fills the corrugation 910, which may increase back pressure flow resistance to redirect or reduce gas flows. This may partially block the flow of gas through corrugation 910. Some of the gas flow may be diverted around the outside of corrugation 910. Corrugation 920 has a foot 921 that substantially fills the corrugation 920. This may substantially block the flow of gas through corrugation 920. Gas flow may be reduced due to increased back pressure flow resistance. Gas may instead flow around the outside of corrugation 920, through corrugations that have feet that do not block the flow of gas, such as corrugation 900 and, to a lesser extent, corrugation 910. As discussed above, a foot 314 may extend vertically beyond the upper ends of the flanges 312. For example, the foot 314 shown in FIG. 8 may block substantially all of the space between the flanges 312 and may continue vertically beyond the upper ends of the flanges 312. An unfilled corrugation 205 of a similar height may be formed by depositing foot material on the ends of the flanges 312 to a desired height (forming extended flanges) and then depositing foot material across the gap between the extended flanges. Thus, the overall height of the corrugations 205 (and thereby the overall height of the current collector 300) may be increased without stretching and thinning the flanges 312. The increased height of the corrugations 205 may improve carbon capture in MCFCs.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The terms “attached,” “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of concepts disclosed herein.

What is claimed is:

1. A method of manufacturing a current collector for an electrochemical cell assembly, the method comprising:
providing a base plate comprising a surface;
bend-forming the base plate to create a plurality of open corrugations protruding from the surface, each open corrugation comprising a first flange and a second flange; and
forming a foot between the first flange and the second flange of each open corrugation to close each open corrugation and form a corrugation.

2. The method of claim 1, wherein the feet are formed using selective laser sintering, selective laser melting, laser metal deposition, or other additive manufacturing methods.

3. The method of claim 1, wherein the feet are made from a different material than the base plate.

4. The method of claim 1, wherein the feet are made from nickel or a nickel alloy.

5. The method of claim 1, wherein the current collector is a cathode current collector and the feet are made from aluminum or an aluminum alloy.

6. The method of claim 1, wherein one or more of the feet fill all or substantially all of the corresponding open corrugation to form a sealed corrugation such that gas flow is substantially blocked between the one or more of the feet and the surface of the base plate.

7. The method of claim 6, wherein a pattern of sealed or restricted-opening corrugations is configured to control a gas flow path through the current collector.

8. The method of claim 1, further comprising cutting a pre-bend corrugation pattern into the base plate.

9. The method of claim 8, wherein the pre-bend corrugation pattern is cut by a die.

10. The method of claim 1, further comprising applying a surface treatment to a surface of each first flange and a surface of each second flange to improve bonds between the foot and the flanges.

11. A current collector for an electrochemical cell assembly, the current collector comprising:
a base plate made from a first material; and
a plurality of corrugations, each corrugation comprising a first flange, a second flange, and a foot formed between the first flange and the second flange, wherein one or more of the feet are made from a second material.

12. The current collector of claim 11, wherein the feet are metallically joined to the flanges.

13. The current collector of claim 11, wherein the first material is stainless steel and the second material is nickel or a nickel alloy.

14. The current collector of claim 11, wherein the first material is stainless steel and the second material is aluminum or an aluminum alloy.

15. The current collector of claim 11, wherein one or more of the feet substantially fill a space between the first flange and the second flange of a corresponding corrugation such that gas flow between the one or more of the feet and a surface of the base plate is substantially blocked.

16. The current collector of claim 15, wherein a pattern of sealed open corrugations is configured to control a gas flow path through the current collector.

17. The current collector of claim 11, wherein the first flange and the second flange of each corrugation is formed from a bent portion of the base plate.

18. An electrochemical cell stack comprising:
an electrochemical cell comprising an anode and a cathode;
a bipolar plate; and
a current collector disposed between the bipolar plate and the electrochemical cell, the current collector comprising a first surface in contact with the bipolar plate and plurality of corrugations each comprising two flanges and a foot extending between the two flanges;
wherein the foot of at least one of the plurality of corrugations is made from a material that is different than a material of the corresponding flanges.

19. The electrochemical cell stack of claim 18, wherein the first material is nickel or a nickel alloy and the feet are in contact with the anode or the cathode.

20. The electrochemical cell stack of claim 18, wherein the first material is aluminum or an aluminum alloy and the feet are in contact with the cathode.
